(19) United States
(12) Patent Application Publication
(10) Pub. No.: US 2011/0050906 A1
(43) Pub. Date: Mar. 3, 2011

(54) COLOR ADJUSTING METHOD FOR DISPLAY

(75) Inventors: Pei-Tang Su, Taipei County (TW); Chao-Chinge Chen, Taipei County (TW)

(73) Assignee: AMTRAN TECHNOLOGY CO. LTD, Taipei County (TW)

(21) Appl. No.: 12/573,148

(22) Filed: Oct. 4, 2009

(30) Foreign Application Priority Data
Sep. 3, 2009 (TW) 98129720

(51) Int. Cl. H04N 17/00

(52) U.S. Cl. 348/179; 348/E17.001

(57) ABSTRACT

A color adjusting method for a display is provided. The color adjusting method includes establishing a primary color adjusting mode in an on-screen-display (OSD) menu of the display, wherein the primary color adjusting mode at least has one of red, green and blue color adjusting mode items; providing a standard test video signal to the display so as to make that the display displays a standard test pattern; and when one of the red, green, blue color adjusting mode items under the primary color adjusting mode is turned on, attenuating (green and blue)/(red and blue)/(red and green) components in the standard test pattern, so as to make that the display only displays one of the red, green, blue components in the standard test pattern, and thus adjusting one of the red, green, blue colors by users.

### CROSS-REFERENCE TO RELATED APPLICATION

This application claims the priority benefit of Taiwan application serial no. 98129720, filed Sep. 3, 2009. The entirety of the above-mentioned patent application is hereby incorporated by reference herein and made a part of specification.

### BACKGROUND OF THE INVENTION

1. Field of the Invention

The present invention relates to a method for promoting frame quality, more particularly, to a color adjusting method capable of making that the video signal can be truly/correctly displayed on the display.

2. Description of the Related Art

In general, for making that the video signal sent by a far end can be truly/correctly displayed on the display (i.e. the correctness for the display processing the video signal, or the match of the display and the video signal), users can adjust three primary colors (i.e. red, green, blue) of the display in advance through some auxiliary tools to realize.

For example, uses can buy a disk with a standard test pattern such as a color bar test pattern to place in, for example, a DVD or CD player to simulate and serve the video signal (i.e. signal source) sent as the far end to the display, and thereafter, users must alternately wear/handheld red, green or blue color filter fabricated as eyeglasses form to watch the standard test pattern displayed on the display, so as to adjust the red, green, blue colors through the on-screen-display (OSD) of the display, respectively.

However, the error, aging or other factors between different color filters may cause the deviation of color adjusting for display, and, finally, thus causing that the video signal can not be truly/correctly displayed on the display. In addition, since users must alternately wear/handheld red, green or blue color filter fabricated as eyeglasses form to watch the standard test pattern displayed on the display, so as to adjust the red, green, blue colors through the OSD of the display, respectively. Therefore, in practical, it is quite inconvenience and troublesome to users.

### SUMMARY OF THE INVENTION

Accordingly, the present invention is directed to a color adjusting method for a display comprising establishing a primary color adjusting mode in an on-screen-display (OSD) menu of the display, wherein the primary color adjusting mode at least has red color adjusting mode item; providing a standard test video signal to the display so as to make that the display displays a standard test pattern; and when the red color adjusting mode item under the primary color adjusting mode is turned on, attenuating green and blue components in the standard test pattern, so as to make that the display only displays red component in the standard test pattern, and thus adjusting the red color by users.

In an embodiment of the present invention, the primary color adjusting mode further has green color adjusting mode item, such that when the green color adjusting mode item under the primary color adjusting mode is turned on, attenuating red and blue components in the standard test pattern, so as to make that the display only displays green component in the standard test pattern, and thus adjusting the green color by users.

In an embodiment of the present invention, the primary color adjusting mode further has blue color adjusting mode item, such that when the blue color adjusting mode item under the primary color adjusting mode is turned on, attenuating red and green components in the standard test pattern, so as to make that the display only displays blue component in the standard test pattern, and thus adjusting the blue color by users.

In an embodiment of the present invention, the red, green or blue color adjusting mode item under the primary color adjusting mode is determined to be turned on or turned off according to a user's command.

In an embodiment of the present invention, when all of the red, green and blue color adjusting mode items under the primary color adjusting mode are not turned on, making that the display maintains to display the standard test pattern.

From the above, the color adjusting method for the display submitted by the present invention realizes to separate from three primary colors directly by the display terminal, so as to replace the traditional method in which users must alternately wear/handheld red, green or blue color filter fabricated as eyeglasses form to watch the standard test pattern displayed on the display. Therefore, the inconvenience and troublesome brought by using different color filters can be avoided, so as to increase the practical and convenience; any deviation of color adjusting for display can be avoided so as to make that the video signal sent by a far end can be truly/correctly displayed on the display; and the cost of using different color filters can be avoided so as to save cost.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of a color adjusting method for a display according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

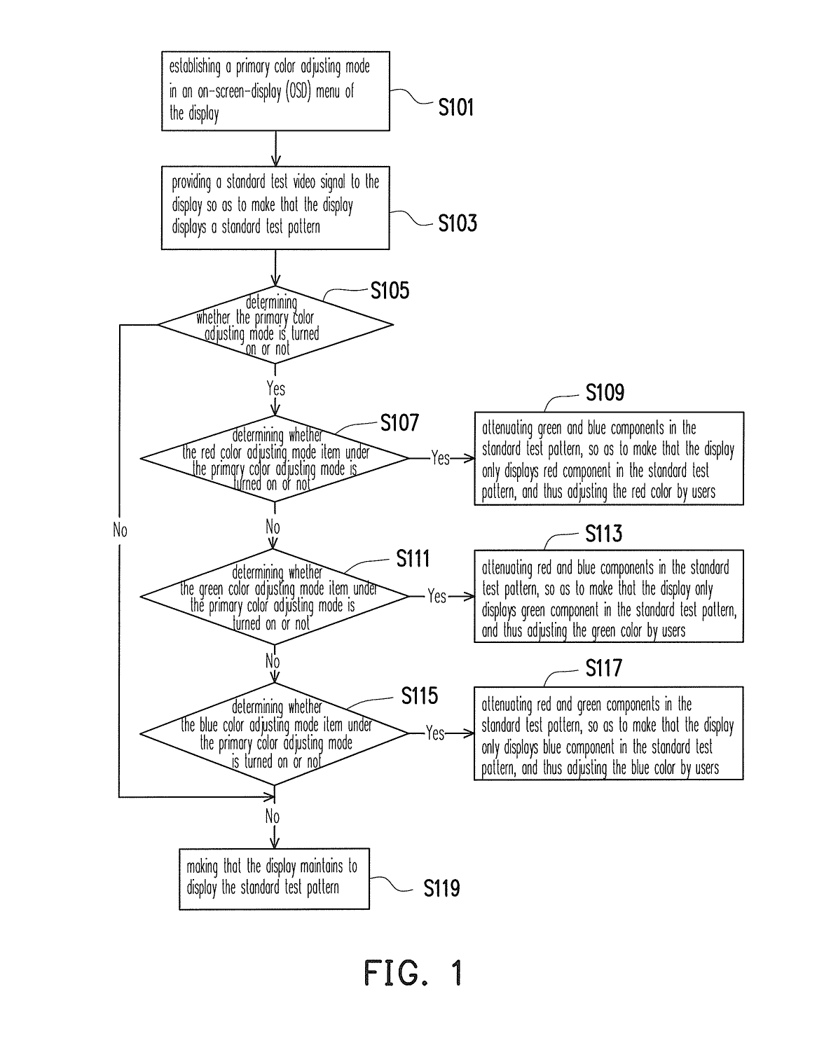

FIG. 1 is a flow chart of a color adjusting method for a display according to an embodiment of the present invention. Referring to FIG. 1, the color adjusting method of the present embodiment includes the following steps of, firstly, establishing a primary color adjusting mode in an on-screen-display (OSD) menu of the display (Step S101), wherein the primary color adjusting mode at least has red (R) and/or green (G) and/or blue (B) color adjusting mode items, namely, all of possible combination among red, green and blue colors. In the present embodiment, the primary color adjusting mode has red, green and blue color adjusting mode items for explaining, but not limited thereto.

Next, providing a standard test video signal to the display so as to make that the display displays a standard test pattern (Step S103). In the present embodiment, users can buy a disk with a standard test pattern to place in, for example, a DVD or CD player to simulate and serve the video signal (i.e. signal source) sent as the far end to the display. Then, the display can display, the standard test pattern such as a color bar test pattern, but not limited thereto.

Next, determining whether the primary color adjusting mode is turned on or not (Step S105). In the present embodiment, the primary color adjusting mode is determined to be turned on according to a user's command. For example, when users intend to turn on the primary color adjusting mode in the OSD menu of the display, users can use a remoter or directly press function buttons configured on a side portion of the display so as to initiate/call the OSD menu popup of the display. Thus, users can determine whether to turn on the primary color adjusting mode merely by entering the primary color adjusting mode in the OSD menu with use of a guiding cursor.

When users decide to turn on the primary color adjusting mode, i.e. the determined result is “Yes” in step S105, proceeding to determine whether the red color adjusting mode item under the primary color adjusting mode is turned on or not (Step S107); on the contrary, making that the display maintains to display the standard test pattern (Step S119).

In the present embodiment, the red, green or blue color adjusting mode item under the primary color adjusting mode is also determined to be turned on according to a user's command. To be specific, when users intend to turn on the red color adjusting mode item under the primary color adjusting mode, users can use the remoter or directly press the function buttons configured on the side portion of the display, and enter the red color adjusting mode item under the primary color adjusting mode with use of the guiding cursor.

Accordingly, when users decide to turn on the red color adjusting mode item under the primary color adjusting mode, i.e. the determined result is “Yes” in step S107, attenuating green and blue components in the standard test pattern, so as to make that the display only displays red component in the standard test pattern, and thus users can adjust the red color through the OSD of the display (Step S109). In the other hands, when users do not decide to turn on the red color adjusting mode item under the primary color adjusting mode, i.e. the determined result is “No” in step S107, proceeding to determine whether the green color adjusting mode item under the primary color adjusting mode is turned on or not (Step S111).

Similarly, when users intend to turn on the green color adjusting mode item under the primary color adjusting mode, users can use the remoter or directly press the function buttons configured on the side portion of the display, and enter the green color adjusting mode item under the primary color adjusting mode with use of the guiding cursor.

Accordingly, when users decide to turn on the green color adjusting mode item under the primary color adjusting mode, i.e. the determined result is “Yes” in step S111, attenuating red and blue components in the standard test pattern, so as to make that the display only displays green component in the standard test pattern, and thus users can adjust the green color through the OSD of the display (Step S113). In the other hands, when users do not decide to turn on the green color adjusting mode item under the primary color adjusting mode, i.e. the determined result is “No” in step S111, proceeding to determine whether the blue color adjusting mode item under the primary color adjusting mode is turned on or not (Step S115).

Similarly, when users intend to turn on the blue color adjusting mode item under the primary color adjusting mode, users can use the remoter or directly press the function buttons configured on the side portion of the display, and enter the blue color adjusting mode item under the primary color adjusting mode with use of the guiding cursor.

Accordingly, when users decide to turn on the blue color adjusting mode item under the primary color adjusting mode, i.e. the determined result is “Yes” in step S115, attenuating red and green components in the standard test pattern, so as to make that the display only displays blue component in the standard test pattern, and thus users can adjust the blue color through the OSD of the display (Step S117). In the other hands, when users do not decide to turn on the blue color adjusting mode item under the primary color adjusting mode, i.e. the determined result is “No” in step S115, it can be interpreted as all of the red, green and blue color adjusting mode items under the primary color adjusting mode are not turned on, such that, making that the display maintains to display the standard test pattern (Step S119).

In the present embodiment, even though sequentially to determine whether the red, green, blue color adjusting mode items under the primary color adjusting mode are turned on or not for explaining, but the present invention is not limited thereto. In other words, the determination order of the red, green, blue color adjusting mode items under the primary color adjusting mode can be adaptively/correspondingly changed according to practical design requirement, and such various embodiments also should fall into the scope of the present invention.

In addition, in the present embodiment, the way of attenuating (green and blue)/(red and blue)/(red and green) components in the standard test pattern may establish three color gains in a controller of the display, namely, a red color gain, a green gain and a blur gain. Accordingly, users only adjust the value of the red, green and blue gains (the value range, for example, between 0-250) by the OSD of the display, the display can only display single color component in the standard test pattern as scheduled. For example, if users adjust the value of the green and blue gains to zero, and the value of the red gain is maintained to 250, such that the display can only display red color component in the standard test pattern as scheduled. Moreover, the way of only displaying green or blue component in the standard test pattern displayed on the display is similarly to this example, so that the detail description would be omitted herein.

In summary, the color adjusting method for the display submitted by the present invention realizes to separate from three primary colors directly by the display terminal, so as to replace the traditional method in which users must alternately wear/handheld red, green or blue color filter fabricated as eyeglasses form to watch the standard test pattern displayed on the display. Therefore, the inconvenience and troublesome brought by using different color filters can be avoided, so as to increase the practical and convenience; any deviation of color adjusting for display can be avoided so as to make that the video signal sent by a far end can be truly/correctly displayed on the display; and the cost of using different color filters can be avoided so as to save cost.

It will be apparent to those skills in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A color adjusting method for a display, comprising:
establishing a primary color adjusting mode in an on-screen-display (OSD) menu of the display, wherein the primary color adjusting mode at least has red color adjusting mode item;
providing a standard test video signal to the display so as to make that the display displays a standard test pattern; and
when the red color adjusting mode item under the primary color adjusting mode is turned on, attenuating green and blue components in the standard test pattern, so as to make that the display only displays red component in the standard test pattern, and thus adjusting the red color by users.

2. The color adjusting method according to claim 1, wherein the primary color adjusting mode further has green color adjusting mode item, and the method further comprises:
when the green color adjusting mode item under the primary color adjusting mode is turned on, attenuating red and blue components in the standard test pattern, so as to make that the display only displays green component in the standard test pattern, and thus adjusting the green color by users.

3. The color adjusting method according to claim 2, wherein the primary color adjusting mode further has blue color adjusting mode item, and the method further comprises:
when the blue color adjusting mode item under the primary color adjusting mode is turned on, attenuating red and green components in the standard test pattern, so as to make that the display only displays blue component in the standard test pattern, and thus adjusting the blue color by users.

4. The color adjusting method according to claim 3, wherein the red, green or blue color adjusting mode item under the primary color adjusting mode is determined to be turned on according to a user's command.

5. The color adjusting method according to claim 3, further comprising:
when all of the red, green and blue color adjusting mode items under the primary color adjusting mode are not turned on, making that the display maintains to display the standard test pattern.
